(19) United States
(12) Patent Application Publication
(10) Pub. No.: US 2012/0076276 A1
(43) Pub. Date: Mar. 29, 2012

(54) CAPACITOR AC POWER COUPLING ACROSS HIGH DC VOLTAGE DIFFERENTIAL

(75) Inventors: Dongbing Wang, Lathrop, CA (US); Dave Reynolds, Orem, UT (US)

(73) Assignee: MOXTEK, INC., Orem, UT (US)

(21) Appl. No.: 12/890,325

(22) Filed: Sep. 24, 2010

(51) Int. Cl. H05G 1/10; H01J 35/02

(52) U.S. Cl. 378/107; 378/121

(57) ABSTRACT

A circuit providing reliable voltage isolation between a low and high voltage sides of a circuit while allowing AC power transfer between the low and high voltage sides of the circuit to an x-ray tube filament. Capacitors provide the isolation between the low and high voltage sides of the circuit.

### BACKGROUND

In certain applications, there is a need to transfer alternating current (AC) power from an AC power source to a load in a circuit in which there is a very large direct current (DC) voltage differential between the AC power source and the load. A transformer is often used in such applications for isolating the AC power source from the load.

For example, in an x-ray tube, a cathode is electrically isolated from an anode. A power supply can provide a DC voltage differential between the cathode and the anode of typically about 4-150 kilovolts (kV). This very large voltage differential between the cathode and the anode provides an electric field for accelerating electrons from the cathode to the anode. The cathode can include a cathode element for producing electrons. The cathode element is a load in the circuit. A power supply can also provide an alternating current to the cathode element in order to heat the cathode element for electron emission from the cathode element. For instance, the alternating current may be supplied by a separate power supply or an AC power source embedded with the DC power supply.

There is a very large DC voltage differential between the AC power source and the cathode element, such as about 4-150 kilovolts (kV). The AC power source can be part of a low voltage side of the circuit and the cathode element can be part of a high voltage side of the circuit. A transformer is normally used to isolate the AC power source from the cathode element, or in other words the transformer can isolate the low voltage side of the circuit from the high DC voltage side of the circuit.

Due to the very high DC voltage differential between the AC power source and the load, arcing can occur at the transformer between the wires on the low voltage side of the transformer and the wires on the high voltage side of the transformer. Such arcing can reduce or destroy the DC voltage differential and thus reduce or destroy cathode electron emission and electron acceleration between the cathode and the anode. Although increased wire insulation can help to reduce this problem, defects in the wiring insulation can result in arcing. Also, due to space constraints, especially in miniature x-ray tubes, increased wiring insulation may not be feasible.

### SUMMARY

It has been recognized that it would be advantageous to transfer AC power from an AC power source to a load in a circuit in which there is a very large DC voltage differential between the AC power source and the load without the use of a transformer and without problems of arcing between the two sides of the circuit.

The present invention is directed to a circuit for supplying AC power to a load in a circuit in which there is a large DC voltage differential between an AC power source and the load. Capacitors are used to provide voltage isolation while providing efficient transfer of AC power from the AC power source to the load. The DC voltage differential can be at least about 1 kV. This invention satisfies the need for reliably and efficiently transferring AC power across a large DC voltage differential.

The present invention can be used in an x-ray tube in which (1) the load can be a cathode element which is electrically isolated from an anode, and (2) there exists a very large DC voltage differential between the cathode element and the anode. AC power supplied to the cathode element can heat the cathode and due to such heating, and the large DC voltage differential between the cathode element and the anode, electrons can be emitted from the cathode element and propelled towards the anode.

### BRIEF DESCRIPTION OF THE DRAWINGS

FIG. 1 is a schematic of a circuit for supplying alternating current to a load, with a high voltage DC power source on the load side of the circuit, in accordance with an embodiment of the present invention;

FIG. 2 is a schematic of a circuit for supplying alternating current to a load, with a high voltage DC power source on the AC power source side of the circuit, in accordance with an embodiment of the present invention;

FIG. 3 is a schematic of a circuit for supplying alternating current to a load, with a high voltage DC power source connected between the load side of the circuit and the AC power source side of the circuit, in accordance with an embodiment of the present invention;

FIG. 4 is a schematic cross-sectional side view of an x-ray tube utilizing a circuit for supplying alternating current to a load in accordance with an embodiment of the present invention; and

FIG. 5 is a flow chart depicting a method for heating a cathode filament in an x-ray tube in accordance with an embodiment of the present invention.

### DEFINITIONS

As used in this description and in the appended claims, the following terms are defined
As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.
As used herein, the term “about” is used to provide flexibility to a numerical range endpoint by providing that a given value may be “a little above” or “a little below” the endpoint.
As used herein, the term “capacitor” means a single capacitor or multiple capacitors in series.
As used herein, the term “high voltage” or “higher voltage” refer to the DC absolute value of the voltage. For example, negative 1 kV and positive 1 kV would both be considered to be “high voltage” relative to positive or negative 1 V. As another example, negative 40 kV would be considered to be “higher voltage” than 0 V.
As used herein, the term “low voltage” or “lower voltage” refer to the DC absolute value of the voltage. For example, negative 1 V and positive 1 V would both be considered to be “low voltage” relative to positive or negative 1 kV. As another example, positive 1 V would be considered to be “lower voltage” than 40 kV.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

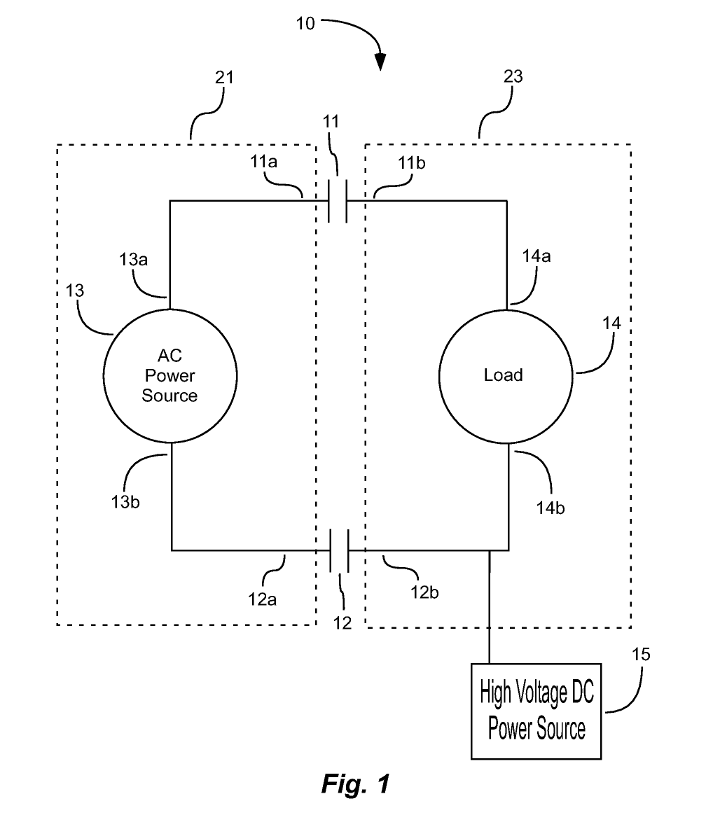

As illustrated in FIG. 1, a circuit, shown generally at 10, for supplying AC power to a load 14, includes an AC power source 13 having a first connection 13a and a second connection 13b, a first capacitor 11 having a first connection 11a and a second connection 11b, and a second capacitor 12 having a first connection 12a and a second connection 12b. The first connection of the AC power source 13a is connected to the first connection on the first capacitor 11a. The second connection of the AC power source 13b is connected to the first connection on the second capacitor 12a. The AC power source 13, the first and second connections on the AC power source 13a-b, the first connection on the first capacitor 11a, and the first connection on the second capacitor 12a comprise a first voltage side 21 of the circuit.

The circuit 10 for supplying AC power to a load further comprises the load 14 having a first connection 14a and a second connection 14b. The second connection of the first capacitor 11b is connected to the first connection on the load 14a and the second connection of the second capacitor 12b is connected to the second connection on the load 14b. The load 14, the first and second connections on the load 14a-b, the second connection on the first capacitor 11b, and the second connection on the second capacitor 12b comprise a second voltage side 23 of the circuit.

The first and second capacitors 11, 12 provide voltage isolation between the first and second voltage sides 21, 23 of the circuit, respectively. A high voltage DC source can provide at least 1 kV DC voltage differential between the first 21 and second 23 voltage sides of the circuit.

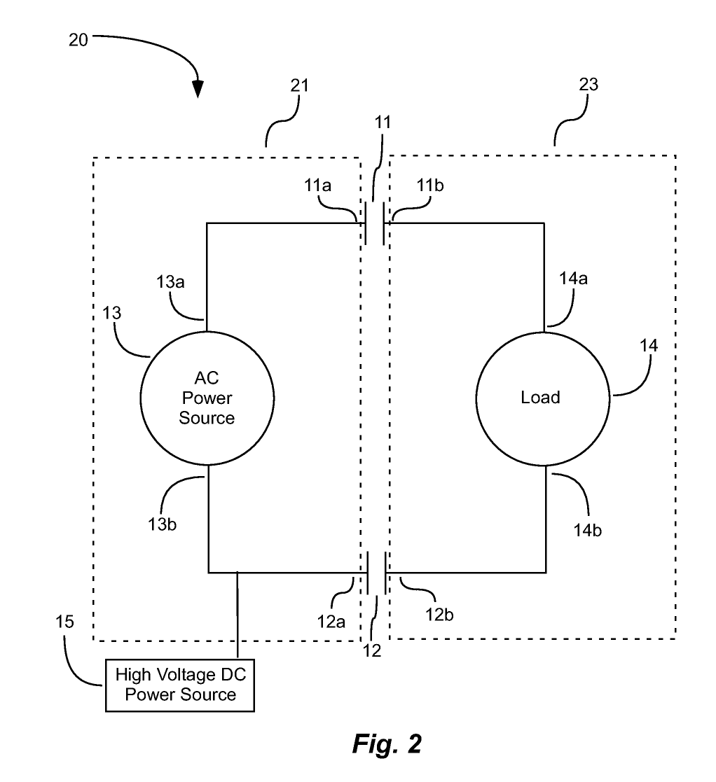

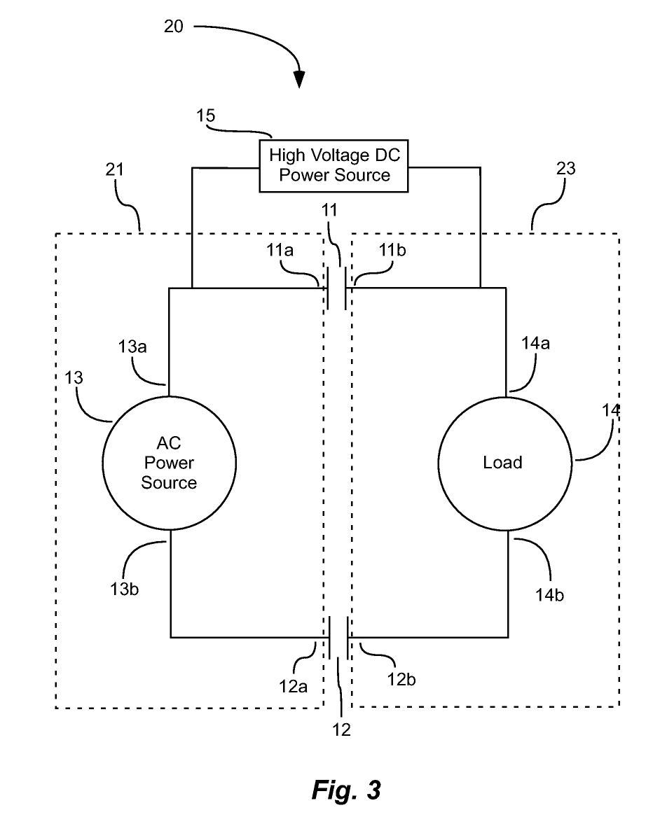

As shown in FIG. 1, the high voltage DC power source 15 can be electrically connected to the second voltage side 23 of the circuit 10, such that the second voltage side of the circuit is a substantially higher voltage than the first voltage side 21 of the circuit. Alternatively, as shown in FIG. 2, the high voltage DC power source 15 can be electrically connected to the first voltage side 21 of the circuit 20, such that the first voltage side of the circuit has a substantially higher voltage than the second voltage side 23 of the circuit. As shown in FIG. 3, the high voltage DC power source 15 can be electrically connected between the first 21 and second 23 voltage sides of the circuit 30 to provide a large DC voltage potential between the two sides of the circuit.

The DC voltage differential between the first 21 and second 23 voltage sides of the circuit can be substantially greater than 1 kV. For example the DC voltage differential between the first and second voltage sides of the circuit can be greater than about 4 kV, greater than about 10 kV, greater than about 20 kV, greater than about 40 kV, or greater than about 60 kV.

The AC power source 13 can transfer at least about 0.1 watt, at least about 0.5 watt, at least about 1 watt, or at least about 10 watts of power to the load 14.

Sometimes a circuit such as the example circuit displayed in FIGS. 1-3 needs to be confined to a small space, such as for use in a portable tool. In such a case, it is desirable for the capacitors to have a small physical size. Capacitors with lower capacitance C are typically smaller in physical size. However, use of a capacitor with a lower capacitance can also result in an increased capacitive reactance X_{c}. A potential increase in capacitive reactance X_{c} due to lower capacitance C of the capacitors can be compensated for by increasing the frequency f supplied by the AC power source, as shown in the formula:

$${X}_{c} = \frac{1}{2 * pi * f * C} .$$

In selected embodiments of the present invention, the capacitance of the first and second capacitors can be greater than about 10 pF or in the range of about 10 pF to about 1 μF. In selected embodiments of the present invention the alternating current may be supplied to the circuit 10 at a frequency f of at least about 1 MHz, at least about 500 MHz, or at least about 1 GHz.

For example, if the capacitance C is 50 pF and the frequency f is 1 GHz, then the capacitive reactance X, is about 3.2. In selected embodiments of the present invention, the capacitive reactance X, of the first capacitor 11 can be in the range of 0.2 to 12 ohms and the capacitive reactance X_{c} of the second capacitor 12 can be in the range of 0.2 to 12 ohms.

It may be desirable, especially in very high voltage applications, to use more than one capacitor in series. In deciding the number of capacitors in series, manufacturing cost, capacitor cost, and physical size constraints of the circuit may be considered. Accordingly, the first capacitor 11 can comprise at least 2 capacitors connected in series and the second capacitor 12 can comprise at least 2 capacitors connected in series.

In one embodiment, the load 14 in the circuit 10 can be a cathode element such as a filament in an x-ray tube.

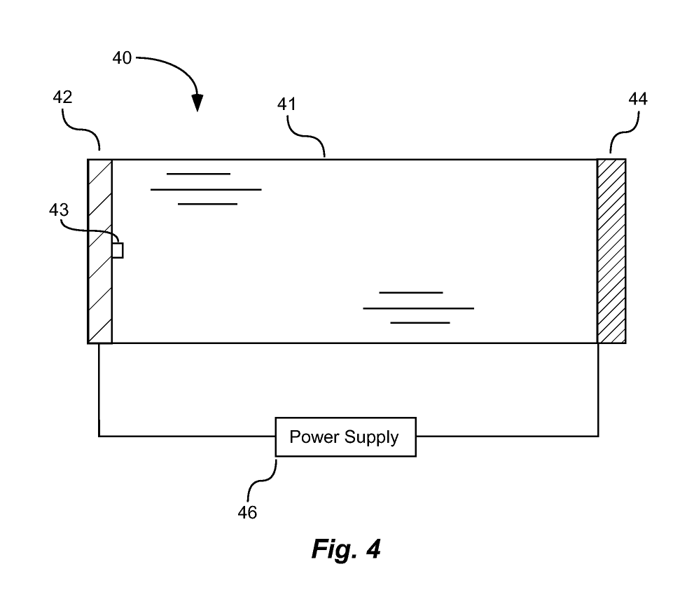

As shown in FIG. 4, the circuits 10, 20, 30 for supplying AC power to a load 14 as described above and shown in FIGS. 1-3 may be used in an x-ray tube 40. The x-ray tube 40 can comprise an evacuated dielectric tube 41 and an anode 44 that is disposed at an end of the evacuated dielectric tube 41. The anode can include a material that is configured to produce x-rays in response to the impact of electrons, such as silver, rhodium, tungsten, or palladium. The x-ray tube further comprises a cathode 42 that is disposed at an opposite end of the evacuated dielectric tube 41 opposing the anode 44. The cathode can include a cathode element 43, such as a filament, that is configured to produce electrons which can be accelerated towards the anode 44 in response to an electric field between the anode 44 and the cathode 42.

A power supply 46 can be electrically coupled to the anode 44, the cathode 42, and the cathode element 43. The power supply 46 can include an AC power source for supplying AC power to the cathode element 43 in order to heat the cathode element, as described above and shown in FIGS. 1-3. The power supply 46 can also include a high voltage DC power source connected to at least one side of the circuit and configured to provide: (1) a DC voltage differential between the first and second voltage sides of the circuit; and (2) the electric field between the anode 44 and the cathode 42. The DC voltage differential between the first and second voltage sides of the circuit can be provided as described above and shown in FIGS. 1-3.

### Methods for Providing AC Power to a Load

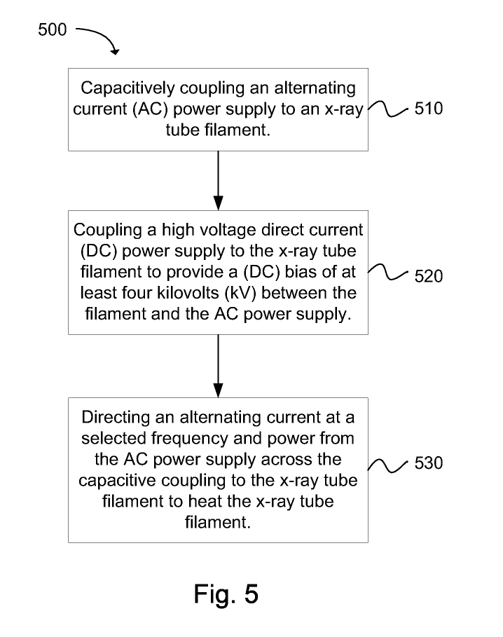

In accordance with another embodiment of the present invention, a method 500 for providing AC power to a load is disclosed, as depicted in the flow chart of FIG. 5. The method can include capacitively coupling 510 an AC power supply to a load. A high voltage DC power supply can be coupled 520 to one of the load or the AC power supply to provide a DC bias of at least 1 kV between the load and the AC power supply. An alternating current at a selected frequency and power can be directed from the AC power supply across the capacitive coupling to the load.

The DC power supply can provide a DC voltage differential between the load and the AC power supply that is substantially higher than 1 kV. For example the DC voltage differential can be greater than about 4 kV, greater than about 20 kV, greater than about 40 kV, or greater than about 60 kV.

In various embodiments of the present invention, the power transferred to the load can be at least about 0.1 watt, at least about 0.5 watt, at least about 1 watt, or at least about 10 watts. In various embodiments of the present invention, the AC power supply can be capacitively coupled to the load with single capacitors or capacitors in series. The capacitance of the capacitors, or capacitors in series, can be greater than about 10 pF or in the range of about 10 pF to about 1 μF. In embodiments of the present invention the selected frequency may be at least about 1 MHz, at least about 500 MHz, or at least about 1 GHz.

In the above described methods, the AC power coupled to the load can be used to heat the load. The load can be an x-ray tube cathode element, such as a filament.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. An x-ray source comprising:
a) an evacuated dielectric tube;
b) an anode, disposed at an end of the tube, including a material configured to produce x-rays in response to an impact of electrons;
c) a cathode, disposed at an opposite end of the tube opposing the anode, including a cathode element configured to produce electrons accelerated towards the anode in response to an electric field between the anode and the cathode;
d) a power supply electrically coupled to the anode, the cathode, and the cathode element;
e) the power supply comprising an alternating current (AC) circuit for supplying AC power to the cathode element in order to heat the cathode element, the AC circuit further comprising;
i) an AC power source having a first and a second connection;
ii) a first capacitor having a first connection and a second connection and a second capacitor having a first connection and a second connection;
iii) the first connection of the AC power source connected to the first connection on the first capacitor and the second connection of the AC power source connected to the first connection on the second capacitor;
iv) the AC power source, the first connection on the first capacitor, and the first connection on the second capacitor comprising a first voltage side of the circuit;
v) the cathode element having a first connection and a second connection;
vi) the second connection of the first capacitor connected to the first connection on the cathode element and the second connection of the second capacitor connected to the second connection on the cathode element;
vii) the cathode element, the second connection on the first capacitor, and the second connection on the second capacitor comprising a second voltage side of the circuit;
viii) the first and second capacitors providing voltage isolation between the first and second voltage sides of the circuit; and
e) the power supply further comprising a high voltage direct current (DC) source connected to one of the first and second sides of the circuit and configured to provide a DC voltage differential between the first and second voltage sides of the circuit and to provide the electric field between the anode and the cathode.

2. The x-ray source of claim 1 wherein:
a) the first voltage side of the circuit is a low voltage side of the circuit;
b) the second voltage side of the circuit is a high voltage side of the circuit;
c) the high voltage DC source is electrically connected to the high voltage side of the circuit; and
d) the high voltage DC source is configured to provide at least 4 kilovolts (kV) DC voltage differential between the low voltage side and the high voltage side of the circuit.

3. The x-ray source of claim 1 wherein the first capacitor comprises at least 2 capacitors connected in series and the second capacitor comprises at least 2 capacitors connected in series.

4. The x-ray source of claim 1 wherein the capacitance of the first and second capacitor is greater than about 10 pF.

5. The x-ray source of claim 1 wherein the AC power source is configured to provide alternating current to the circuit at a frequency of at least about 1 MHz.

6. The x-ray source of claim 1 wherein the AC power source transfers at least about 0.1 watt of power to the cathode element.

7. The x-ray source of claim 1 wherein the cathode element is a filament and the AC power source transfers at least about 0.5 watt of power to the filament.

8. The x-ray source of claim 1 wherein the capacitive reactance, X_{c}, of the first capacitor is in the range of 0.2 to 12 ohms and the capacitive reactance of the second capacitor is in the range of 0.2 to 12 ohms.

9. A circuit for supplying alternating current (AC) power to a load, the circuit comprising:
a) an AC power source having a first and a second connection;
b) a first capacitor having a first connection and a second connection and a second capacitor having a first connection and a second connection;
c) the first connection of the AC power source connected to the first connection on the first capacitor and the second connection of the AC power source connected to the first connection on the second capacitor;
d) the AC power source, the first connection on the first capacitor, and the first connection on the second capacitor comprising a first voltage side of the circuit;
e) the load having a first connection and a second connection;
f) the second connection of the first capacitor connected to the first connection on the load and the second connection of the second capacitor connected to the second connection on the load;
g) the load, the second connection on the first capacitor, and the second connection on the second capacitor comprising a second voltage side of the circuit;
h) the first and second capacitors providing voltage isolation between the first and second voltage sides of the circuit; and
i) a high voltage direct current (DC) source connected to the one side of the circuit and configured to provide at least 1 kilovolt (kV) DC voltage differential between the first and second voltage sides of the circuit.

10. The circuit of claim 9 wherein the capacitive reactance, X_{c}, of the first capacitor is in the range of 0.2 to 12 ohms and the capacitive reactance of the second capacitor is in the range of 0.2 to 12 ohms.

11. The circuit of claim 9 wherein the AC power source transfers at least about 0.1 watt of power to the load.

12. The circuit of claim 9 wherein the capacitance of the first and second capacitor is greater than about 10 pF.

13. The circuit of claim 9 wherein the capacitance of the first and second capacitor is in a range of about 10 pF to about 1 μF.

14. The circuit of claim 9 wherein the AC power source is configured to provide alternating current to the circuit at a frequency of at least about 1 MHz.

15. The circuit of claim 9 wherein:
a) the first voltage side of the circuit is a low voltage side of the circuit;
b) the second voltage side of the circuit is a high voltage side of the circuit; and
c) the high voltage DC source is electrically connected to the high voltage side of the circuit.

16. The circuit of claim 15 wherein the high voltage DC source is configured to provide at least 10 kV voltage differential between the low voltage side and the high voltage side of the circuit.

17. The circuit of claim 9 wherein the first capacitor comprises at least 2 capacitors connected in series and the second capacitor comprises at least 2 capacitors connected in series

18. The circuit of claim 9 wherein the load is an x-ray tube filament.

19. A circuit for supplying alternating current (AC) power to a load, the circuit comprising:
a) an AC power source having a first and a second connection;
b) a first capacitor having a first connection and a second connection and a second capacitor having a first connection and a second connection;
c) the first connection of the AC power source connected to the first connection on the first capacitor and the second connection of the AC power source connected to the first connection on the second capacitor;
d) the AC power source, the first connection on the first capacitor, and the first connection on the second capacitor comprising a first voltage side of the circuit;
e) a load having a first connection and a second connection;
f) the second connection of the first capacitor connected to the first connection on the load and the second connection of the second capacitor connected to the second connection on the load;
g) the load, the second connection on the first capacitor, and the second connection on the second capacitor comprising a second voltage side of the circuit;
h) the first and second capacitors providing voltage isolation between the first and second voltage sides of the circuit;
i) a high voltage direct current (DC) source connected to the one side of the circuit and configured to provide at least 4 kilovolts (kV) DC voltage differential between the first and second voltage sides of the circuit;
j) the AC power source transfers at least about 0.1 watts of power to the load; and
k) the AC power source is configured to provide alternating current to the circuit at a frequency of at least about 1 MHz.

20. A method for heating a cathode filament in an x-ray tube, the method comprising:
a) capacitively coupling an alternating current (AC) power supply to an x-ray tube filament;
b) coupling a high voltage direct current (DC) power supply to the x-ray tube filament to provide a (DC) bias of at least four kilovolts (kV) between the filament and the AC power supply; and
c) directing an alternating current at a selected frequency and power from the AC power supply across the capacitive coupling to the x-ray tube filament to heat the x-ray tube filament.
